(19) United States
(12) Patent Application Publication
(10) Pub. No.: US 2012/0064378 A1
(43) Pub. Date: Mar. 15, 2012

(54) SMART PROTECTION FOR A BATTERY PACK

(75) Inventors: CHIN-HUI WANG, NEW TAIPEI CITY (TW); YING-JIE HAN, SHANGHAI CITY (CN); PENG-JU LAN, NEW TAIPEI CITY (TW)

(73) Assignee: RICHPOWER MICROELECTRONICS CORPORATION, GRAND CAYMAN (KY)

(21) Appl. No.: 13/228,621

(22) Filed: Sep. 9, 2011

(30) Foreign Application Priority Data
Sep. 13, 2010 (TW) 099130919

(51) Int. Cl. H01M 10/42; H01M 10/00; H01M 2/00

(52) U.S. Cl. 429/7; 429/61; 429/50

(57) ABSTRACT

A circuit and method are disclosed for providing smart protection to a battery pack against abnormal operation with an electrical switch. The battery cell of the battery pack is monitored to control the electrical switch. If abnormal operation occurs, the electrical switch will turn off to disconnect the battery cell. Once the abnormal condition disappears, the electrical switch will turn on and the battery cell will return to normal state.

### FIELD OF THE INVENTION

The present invention is related generally to a battery pack and, more particularly, to smart protection for a battery pack.

### BACKGROUND OF THE INVENTION

A battery pack is a set of any number of (preferably) identical batteries or individual battery cells. They may be configured in a series, parallel or a mixture of both to deliver the desired voltage, capacity, or power density. As shown in FIG. 1, a single-cell battery pack 10 includes only a battery cell 12 connected between electrodes 14 and 16. For providing protection to the battery cell 12, the battery pack 10 employs a poly fuse 18 connected with the battery cell 12 in series between the electrodes 14 and 16. Once abnormal operation such as over-current or over-temperature happens, a great amount of heat will be generated and the poly fuse 18 will melt and thus prevent the battery pack 10 from damage. However, the response of this protection is slow because it will take several hundreds of milliseconds to melt down the poly fuse 18. Besides, the battery pack 10 will not work until the melted fuse is replaced. Another disadvantage is that the over-current and over-temperature trip points of the poly fuse 18 are inaccurate.

A multi-cell battery pack includes multiple battery cells. For example, as shown in FIG. 2, a multi-cell battery pack 20 includes battery cells 12, 22 and 24 connected in series between electrodes 14 and 16. Similar to that shown in FIG. 1, the battery pack 20 employs a poly fuse 18 connected in series with the serially connected battery cells 12, 22 and 24 for providing protection to the battery cells 12, 22 and 24. This protection has more disadvantages than that of FIG. 1 since the poly fuse 18 and the battery cells 12, 22 and 24 are all connected in series. Once abnormal operation happens to any of the battery cells 12, 22 and 24, for example the battery cell 22, the poly fuse 18 will melt and thus cut off the current path, so that the battery pack 20 will not work even the other battery cells are in normal state.

In the conventional protection, the use of the poly fuse and the configuration of the circuit in the battery pack result in inconvenience of using the battery pack. Therefore, it is desired a new solution for providing protection for a battery pack.

### SUMMARY OF THE INVENTION

An objective of the present invention is to provide a circuit and method for providing smart protection to a battery pack against abnormal operation.

Another objective of the present invention is to provide a battery pack with smart protection.

According to the present invention, a circuit for providing smart protection for a battery pack includes an electrical switch connected to one or more battery cells in series between two electrodes, a sensor detecting for abnormal operation of any of the battery cells, and a controller controlling the electrical switch according to an output signal of the sensor. If abnormal operation occurs to any of the battery cells, the controller will turn off the electrical switch to disconnect the abnormal battery cell, and once the abnormal condition disappears, the controller will turn on the electrical switch for the disconnected battery cell to return to normal operation. A bypass switch is preferably included to be turned on by the controller to bypass the abnormal battery cell for not cutting off the current path between the two electrodes.

According to the present invention, a method for providing smart protection for a battery pack includes monitoring one or more battery cells connected between two electrodes for detecting for abnormal operation of any of the battery cells, turning off an electrical switch connected in series with the battery cells to disconnect the abnormal battery cell, and turning on the electrical switch for the disconnected battery cell to return to normal operation once the abnormal condition disappears. Preferably, a bypass switch is turned on to bypass the abnormal battery cell for not cutting off the current path between the two electrodes.

### BRIEF DESCRIPTION OF THE DRAWINGS

These and other objectives, features and advantages according to the present invention will become apparent to those skilled in the art upon consideration of the following description of the preferred embodiments according to the present invention taken in conjunction with the accompanying drawings, in which:

FIG. 1 shows a conventional single-cell battery pack;

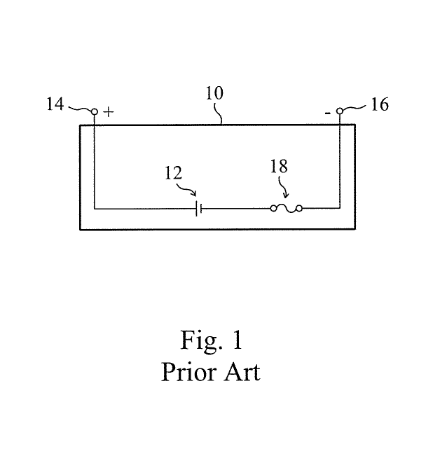

FIG. 2 shows a conventional multi-cell battery pack;

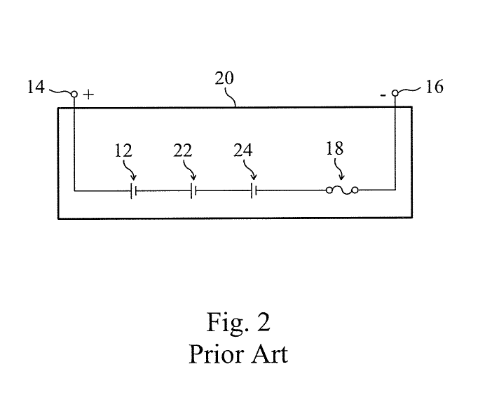

FIG. 3 shows a first embodiment according to the present invention in normal state;

FIG. 4 shows the battery pack of FIG. 3 in abnormal state;

FIG. 5 shows a second embodiment according to the present invention in normal state;

FIG. 6 shows the battery pack of FIG. 5 in abnormal state;

FIG. 7 shows a third embodiment according to the present invention; and

FIG. 8 shows a fourth embodiment according to the present invention.

### DETAILED DESCRIPTION OF THE INVENTION

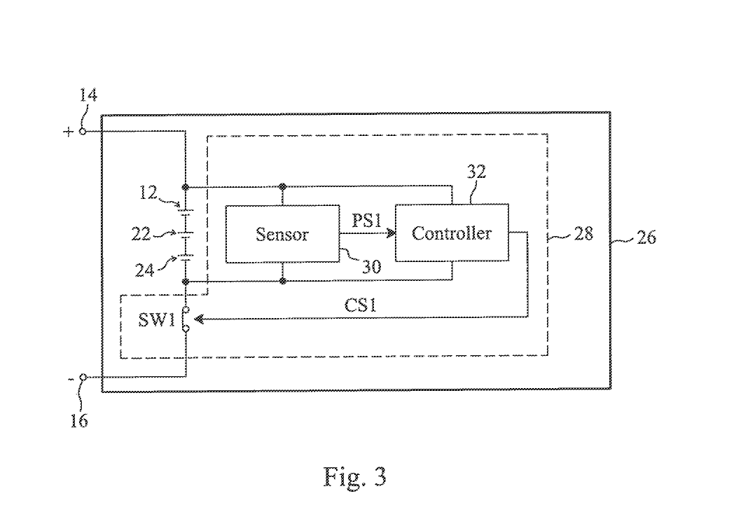

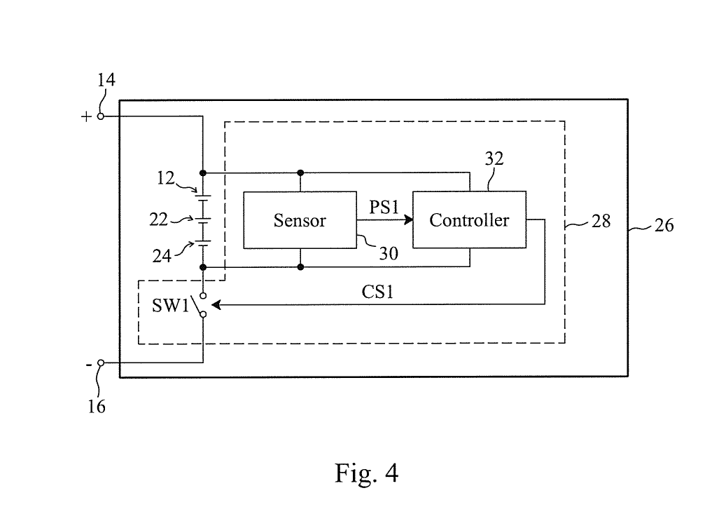

Referring to FIGS. 3 and 4, a multi-cell battery pack 26 according to the present invention includes a circuit 28 for providing smart protection to the battery pack 26 against abnormal operation. In the circuit 28, an electrical switch SW1 is connected to battery cells 12, 22 and 24 in series between electrodes 14 and 16, a sensor 30 is connected to the two ends of the serially connected battery cells 12, 22 and 24 to receive power from the battery cells 12, 22 and 24, and monitor the battery cells 12, 22 and 24 for detecting for abnormal operation of any of the battery cells 12, 22 and 24, for example over-current or over-temperature, and a controller 32 is connected to the two ends of the serially connected battery cells 12, 22 and 24 to receive power from the battery cells 12, 22 and 24, and is connected to the sensor 30 to receive an output signal PS1 of the sensor 30 to determine a control signal CS1 for controlling the electrical switch SW1. For example, the electrical switch SW1 is a power MOSFET. When the battery pack 26 is in normal operation, the electrical switch SW1 is on, as shown in FIG. 3. However, once abnormal operation occurs, the controller 32 will turn off the electrical switch SW1, as shown in FIG. 4, to disconnect the serially connected battery cells 12, 22 and 24. Once abnormal operation does not exist, the controller 32 will turn on the electrical switch SW1 so that the battery pack 26 will function again. The detection for over-current protection (OCP), over-temperature protection (OTP) and many other protections is prior art. Responsive to a signal to generate a control signal for switching an electrical switch is also prior art. Thus, further details of the circuitry of the sensor 30 and the controller 32 is not described hereof.

Although the above embodiment is designed with a multi-cell battery pack for illustration, it is appreciated that the application to single-cell battery packs is the same, only by replacing the battery cells 12, 22 and 24 with a single battery cell.

Since the circuit 28 employs the electrical switch SW1 for providing protection for the battery pack 26, it can precisely set the over-current trip point, over-temperature trip point, or other conditional trip points. In addition, when abnormal operation occurs, the protection response is fast, for example, in only several microseconds, and the battery pack 26 will automatically function again once abnormal operation does not exist. All of these improve the battery pack 26 in convenience of being used.

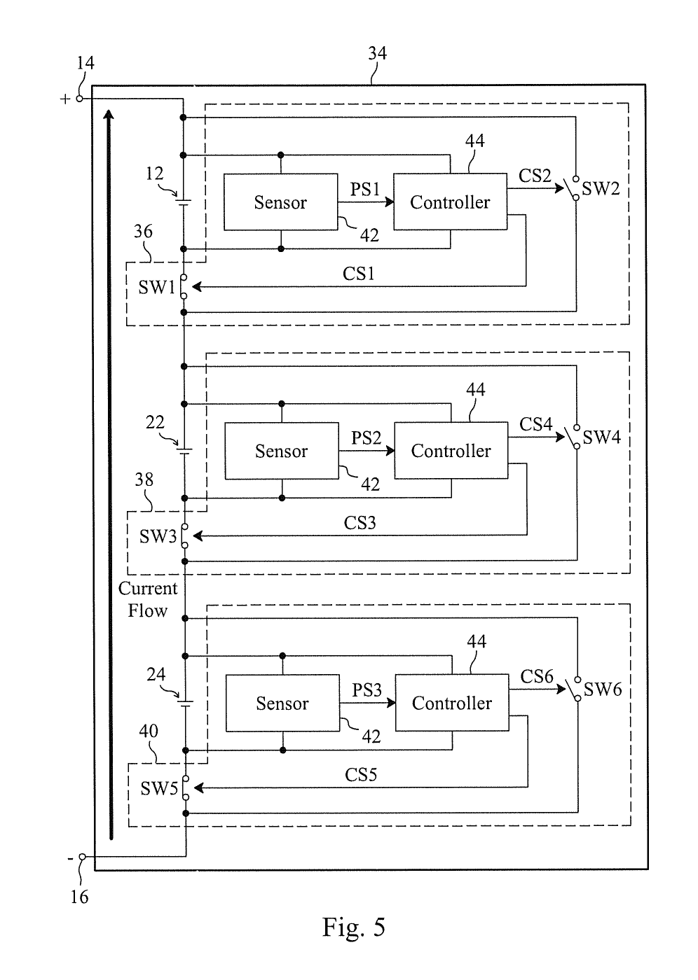

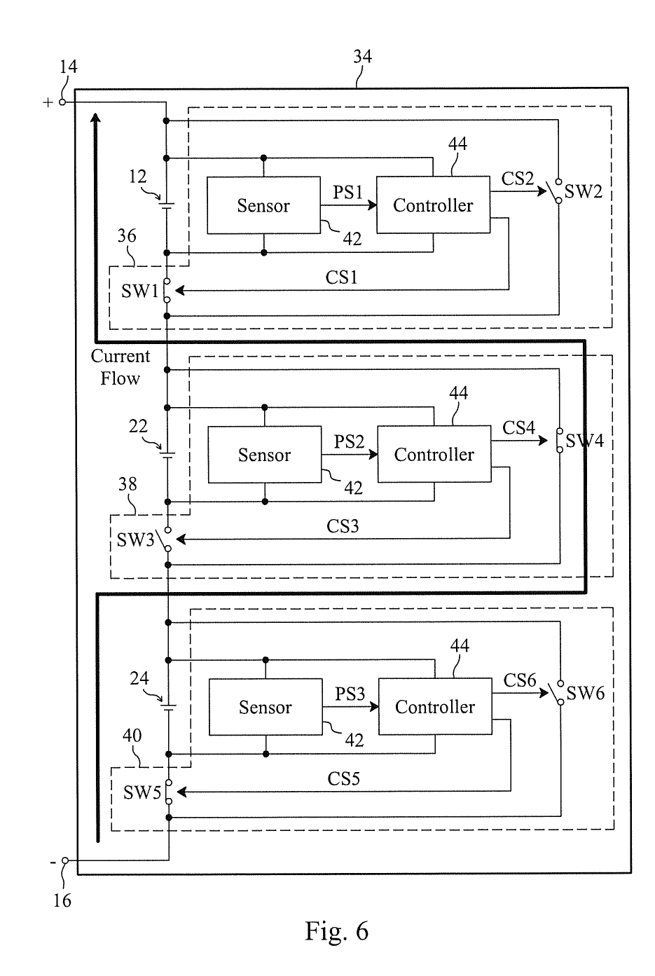

In some other embodiments, each battery cell in a multi-cell battery pack is individually provided with protection. For example, referring to FIG. 5, in a multi-cell battery pack 34, battery cells 12, 22 and 24 are connected in series between electrodes 14 and 16, a circuit includes three units 36, 38 and 40 for protecting the battery cells 12, 22 and 24 respectively. In the unit 36, an electrical switch SW1, a sensor 42 and a controller 44 are configured similar to that of FIG. 3, additionally with a bypass switch SW2 parallel connected to the serially connected electrical switch SW1 and battery cell 12, and responsive to a control signal CS2 provided by the controller 44 to turn off when the battery cell 12 is in normal state and turn on to bypass the battery cell 12 when the battery cell 12 is in abnormal state. Each of the other units 38 and 40 has the same configuration and operation as that of the unit 36. The power required by the units 36, 38 and 40 are provided by the battery cells 12, 22 and 24 they protect respectively. The switches SW1-SW6 are all electrical switches, for example power MOSFETs. Supposed that all the battery cells 12, 22 and 24 are in normal state, as shown in FIG. 5, all the electrical switches SW1, SW3 and SW5 turn on and all the bypass switches SW2, SW4 and SW6 turn off, discharging a current flowing from the electrode 16 to the electrode 14 through the electrical switch SW5, the battery cell 24, the electrical switch SW3, the battery cell 22, the electrical switch SW1 and the battery cell 12. If abnormal operation occurs to any of the battery cells 12, 22 and 24, for example the battery cell 22, as shown in FIG. 6, the electrical switch SW3 will turn off and the bypass switch SW4 will turn on, so that current will not flow through the battery cell 22 but flow through the bypass switch SW4. This solution bypasses the abnormal battery cell without cutting off the current path, and thus the system will keep working even one of the battery cells is malfunctioned. Another advantage of this multi-cell battery protection solution is flexibility. Paralleling protect units to each battery cell, a multi-cell battery protection solution can be setup easily.

Although the embodiment of FIG. 5 is designed with each of the units 36, 38 and 40 for protecting one battery cell, it is appreciated that in different embodiments, one unit may be used for protecting multiple battery cells, as that shown in FIG. 3. It is also appreciated that a bypass switch may be additionally used in the circuit of FIG. 3 as that shown in FIG. 5, to bypass the serially connected battery cells 12, 22 and 24 when abnormal operation occurs to any of the battery cells 12, 22 and 24.

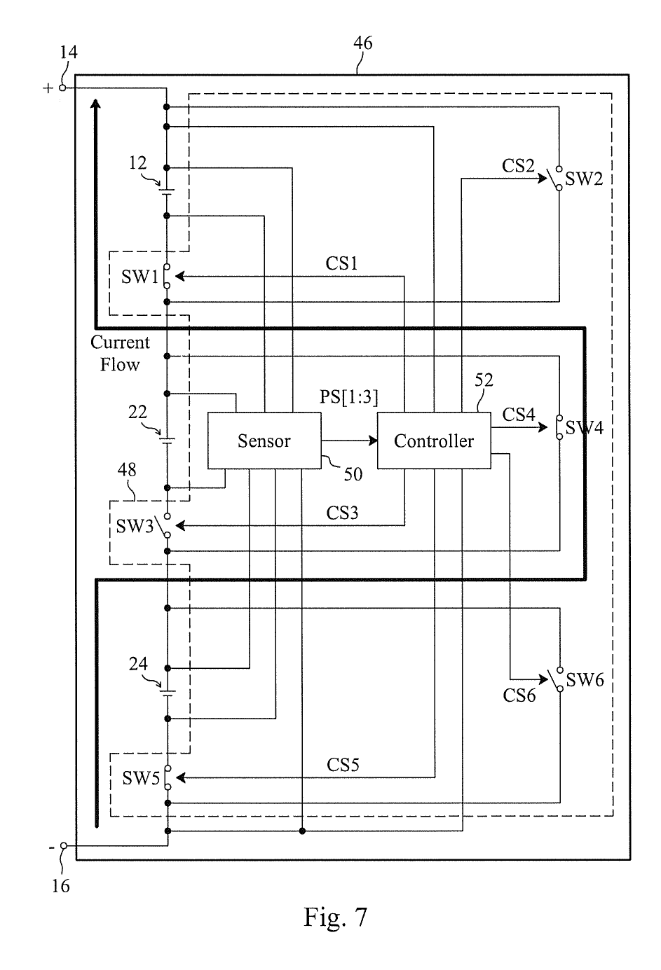

The circuit of FIG. 5 may be modified into another embodiment as shown in FIG. 7. In a multi-cell battery pack 46, the power required by a circuit 48 for providing smart protection is drawn from electrodes 14 and 16, a sensor 50 monitors battery cells 12, 22 and 24 for detecting for abnormal operation of any of the battery cells 12, 22 and 24, and a controller 52 controls switches SW1-SW6 according to an output signal PS[1:3] of the sensor 50. If a multiplexer is used, it will be helpful to significantly downsize the sensor 50.

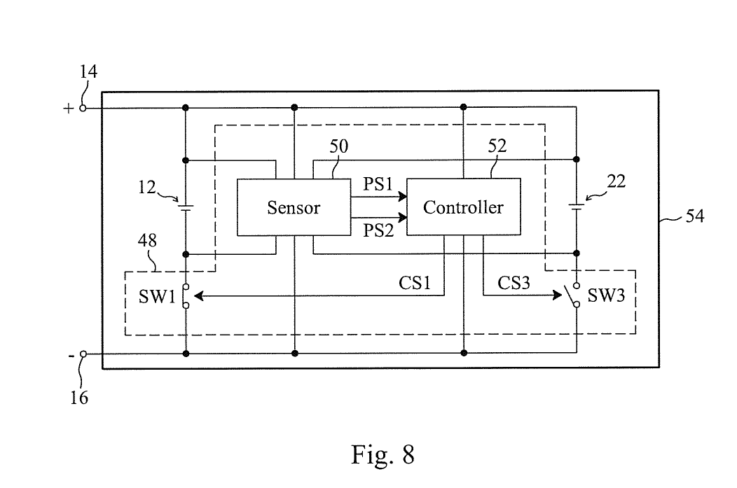

FIG. 8 shows a further embodiment. In a multi-cell battery pack 54, battery cells 12 and 22 are connected in parallel between electrodes 14 and 16, a circuit 48 for providing smart protection includes electrical switches SW1 and SW3 connected in series with the battery cells 12 and 22 respectively, and a sensor 50 and a controller 52 are both powered from the electrodes 14 and 16. The sensor 50 monitors the battery cells 12 and 22 for detecting for abnormal operation of any of the battery cells 12 and 22, the controller 52 controls the electrical switches SW1 and SW3 according to output signals PS1 and PS2 of the sensor 50. For instance, when the battery cell 22 is in abnormal state, the electrical switch SW3 turns off to disconnect the battery cell 22, and once the abnormal condition disappears, the electrical switch SW3 turn on for the battery cell 22 to return to work.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A battery pack comprising:
two electrodes;
a battery cell;
an electrical switch connected in series with the battery cell between the two electrodes;
a sensor connected to the battery cell, monitoring the battery cell for detecting for abnormal operation of the battery cell; and
a controller connected to the sensor, responsive to an output signal of the sensor to control the electrical switch;
wherein the controller turns off the electrical switch when the battery cell is in abnormal state.

2. The battery pack of claim 1, further comprising a bypass switch parallel connected to the serially connected battery cell and electrical switch, being turned on by the controller to bypass the battery cell when the battery cell is in abnormal state.

3. A circuit for providing smart protection for a battery pack having two electrodes and a battery cell, the circuit comprising:
an electrical switch connected in series with the battery cell between the two electrodes;
a sensor connected to the battery cell, monitoring the battery cell for detecting for abnormal operation of the battery cell; and
a controller connected to the sensor, responsive to an output signal of the sensor to control the electrical switch;
wherein the controller turns off the electrical switch when the battery cell is in abnormal state.

4. The circuit of claim 3, further comprising a bypass switch parallel connected to the serially connected battery cell and electrical switch, being turned on by the controller to bypass the battery cell when the battery cell is in abnormal state.

5. A method for providing smart protection for a battery pack having two electrodes and a battery cell, the method comprising the steps of:
connecting an electrical switch in series with the battery cell between the two electrodes;
monitoring the battery cell for detecting for abnormal operation of the battery cell;
turning off the electrical switch when the battery cell is in abnormal state; and
turning on the electrical switch when the abnormal condition disappears.

6. The method of claim 5, further comprising the steps of:
parallel connecting a bypass switch to the serially connected battery cell and electrical switch; and
turning on the bypass switch to bypass the battery cell when the battery cell is in abnormal state.

7. A battery pack comprising:
two electrodes;
a plurality of battery cells connected in series between the two electrodes; and
a circuit connected to the plurality of battery cells for providing smart protection and including a plurality of units, each unit protecting a respective one of the plurality of battery cells and including:
an electrical switch connected in series with the protected battery cell;
a bypass switch parallel connected to the serially connected electrical switch and protected battery cell;
a sensor connected to the protected battery cell, monitoring the protected battery cell for detecting for abnormal operation of the protected battery cell; and
a controller connected to the sensor, responsive to an output signal of the sensor to control the electrical switch and the bypass switch;
wherein the controller turns off the electrical switch and turns on the bypass switch to bypass the protected battery cell when the protected battery cell is in abnormal state.

8. A battery pack comprising:
two electrodes;
two battery cells connected in series between the two electrodes;
a first electrical switch directly connected to the first battery cell in series;
a second electrical switch directly connected to the second battery cell in series;
a first bypass switch parallel connected to the serially connected first battery cell and first electrical switch;
a second bypass switch parallel connected to the serially connected second battery cell and second electrical switch;
a sensor connected to the two battery cells, monitoring the two battery cells for detecting for abnormal operation of any of the two battery cells; and
a controller connected to the sensor, responsive to an output signal of the sensor to control the first and second electrical switches and the first and second bypass switches;
wherein the controller turns off the first electrical switch and turns on the first bypass switch to bypass the first battery cell when the first battery cell is in abnormal state, and turns off the second electrical switch and turns on the second bypass switch to bypass the second battery cell when the second battery cell is in abnormal state.

9. A circuit for providing smart protection for a battery pack having two electrodes and two battery cells connected in series between the two electrodes, the circuit comprising:
a first electrical switch directly connected to the first battery cell in series;
a second electrical switch directly connected to the second battery cell in series;
a first bypass switch parallel connected to the serially connected first battery cell and first electrical switch;
a second bypass switch parallel connected to the serially connected second battery cell and second electrical switch;
a sensor connected to the two battery cells, monitoring the two battery cells for detecting for abnormal operation of any of the two battery cells; and
a controller connected to the sensor, responsive to an output signal of the sensor to control the first and second electrical switches and the first and second bypass switches;
wherein the controller turns off the first electrical switch and turns on the first bypass switch to bypass the first battery cell when the first battery cell is in abnormal state, and turns off the second electrical switch and turns on the second bypass switch to bypass the second battery cell when the second battery cell is in abnormal state.

10. A method for providing smart protection for a battery pack having two electrodes and two battery cells connected in series between the two electrodes, the method comprising the steps of:
configuring a first electrical switch and the first battery cell such that the first electrical switch and the first battery cell are serially and directly connected to each other;
configuring a second electrical switch and the second battery cell such that the second electrical switch and the second battery cell are serially and directly connected to each other;
configuring a first bypass switch and the serially connected first battery cell and first electrical switch such that the first bypass switch is parallel connected to the serially connected first battery cell and first electrical switch;
configuring a second bypass switch and the serially connected second battery cell and second electrical switch such that the second bypass switch is parallel connected to the serially connected second battery cell and second electrical switch;
monitoring the two battery cells for detecting for abnormal operation of any of the two battery cells;
turning off the first electrical switch and turning on the first bypass switch to bypass the first battery cell when the first battery cell is in abnormal state, and turning on the first electrical switch and turning off the first bypass switch when the abnormal condition of the first battery cell disappears; and
turning off the second electrical switch and turning on the second bypass switch to bypass the second battery cell when the second battery cell is in abnormal state, and turning on the second electrical switch and turning off the second bypass switch when the abnormal condition of the second battery cell disappears.

11. A battery pack comprising:
two electrodes;
two battery cells connected in parallel between the two electrodes;
a first electrical switch connected in series with the first battery cell;
a second electrical switch connected in series with the second battery cell;
a sensor connected to the two battery cells, monitoring the two battery cells for detecting for abnormal operation of any of the two battery cells; and
a controller connected to the sensor, responsive to an output signal of the sensor to control the first and second electrical switches;
wherein the controller turns off the first electrical switch when the first battery cell is in abnormal state, and turns off the second electrical switch when the second battery cell is in abnormal state.

12. A circuit for providing smart protection for a battery pack having two electrodes and two battery cells connected in parallel between the two electrodes, the circuit comprising:
a first electrical switch connected in series with the first battery cell;
a second electrical switch connected in series with the second battery cell;
a sensor connected to the two battery cells, monitoring the two battery cells for detecting for abnormal operation of any of the two battery cells; and
a controller connected to the sensor, responsive to an output signal of the sensor to control the first and second electrical switches;
wherein the controller turns off the first electrical switch when the first battery cell is in abnormal state, and turns off the second electrical switch when the second battery cell is in abnormal state.

13. A method for providing smart protection for a battery pack having two electrodes and two battery cells connected in parallel between the two electrodes, the method comprising the steps of:
connecting a first electrical switch in series with the first battery cell;
connecting a second electrical switch in series with the second battery cell;
monitoring the two battery cells for detecting for abnormal operation of any of the two battery cells;
turning off the first electrical switch when the first battery cell is in abnormal state, and turning on the first electrical switch when the abnormal condition of the first battery cell disappears; and
turning off the second electrical switch when the second battery cell is in abnormal state, and turning on the second electrical switch when the abnormal condition of the second battery cell disappears.
